(19) United States
(12) Patent Application Publication
(10) Pub. No.: US 2006/0139352 A1
(43) Pub. Date: Jun. 29, 2006

(54) Computer product, operation-analysis support device, and operation-analysis support method

(75) Inventors: Makoto Kobayashi, Kawasaki (JP); Tsukasa Tenma, Kawasaki (JP); Kouji Demizu, Kawasaki (JP); Yukihiko Furumoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/117,541

(22) Filed: Apr. 29, 2005

(30) Foreign Application Priority Data
Dec. 28, 2004 (JP) 2004-380100

(51) Int. Cl. G06T 11/20

(52) U.S. Cl. 345/440; 705/7

(57) ABSTRACT

A workflow chart, which is a plot of a plurality of blocks connected by a plurality of lines on a coordinate system that has at least a first axis and a second axis, is generated and displayed. Each of the blocks expresses a work and each of the lines expresses a flow between the works. Each block is laid out in a size and at a position along the first axis and the second axis based on a first parameter and a second parameter, respectively. Each line is laid out in a size and at a position along the first axis based on the first parameter.

### BACKGROUND OF THE INVENTION

1) Field of the Invention

The present invention relates to an operation-analysis support program, an operation-analysis support device, and an operation-analysis support method that generate a workflow chart.

2) Description of the Related Art

Workflow charts, part charts, and Gantt charts are typically used to analyze a work flow. These charts have advantages and disadvantages. For example, with workflow charts, relationships between preceding works and succeeding works can be easily understood, however, consumption of time or resources of each work cannot be expressed.

To solve this problem, Japanese Patent Application Laid Open No. 2003-308421 discloses a technology with which values of consumption amounts can be displayed around the block of the work.

However, because the consumption amounts are expressed by values, it is difficult to grasp at a glance the differences in consumption. Moreover, a problem remains that the consumption amounts of transitional parts between each group, also called the flow, cannot be shown.

### SUMMARY OF THE INVENTION

It is an object of the present invention to at least solve the problems in the conventional technology.

According to one aspect of the present invention, a computer-readable recording medium that stores a computer program that causes a computer to generate and display a workflow chart. The workflow chart is a plot of a plurality of blocks connected by a plurality of lines on a coordinate system having at least a first axis and a second axis, and each of the blocks expresses a work and each of the lines expresses a flow between the works. Such computer program causes the computer to execute laying out each of the blocks in a size and at a position along the first axis and the second axis based on a first parameter and a second parameter, respectively, and laying out each of the lines in a size and at a position along the first axis based on the first parameter.

According to another aspect of the present invention, an operation-analysis support device generates and displays a workflow chart, and in the operation-analysis support device, the workflow chart is a plot of a plurality of blocks connected by a plurality of lines on a coordinate system having at least a first axis and a second axis, wherein each of the blocks expresses a work and each of the lines expresses a flow between the works. Such operation-analysis support device includes a layout unit that lays out each of the blocks in a size and at a position along the first axis and the second axis based on a first parameter and a second parameter, respectively, and lays out each of the lines in a size and at a position along the first axis based on the first parameter.

According to still another aspect of the present invention, an operation-analysis support method generates and displays a workflow chart, and in the operation-analysis support method, the workflow chart is a plot of a plurality of blocks connected by a plurality of lines on a coordinate system having at least a first axis and a second axis, wherein each of the blocks expresses a work and each of the lines expresses a flow between the works. Such method includes laying out each of the blocks in a size and at a position along the first axis and the second axis based on a first parameter and a second parameter, respectively, and laying out each of the lines in a size and at a position along the first axis based on the first parameter.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an example of a workflow chart according to an embodiment of the present invention;

FIG. 2 is a block diagram of an operation-analysis support device according to the embodiment of the present invention;

FIG. 3 is an example of data stored in a staff master shown in FIG. 2;

FIG. 4 is an example of data stored in a work consumption master shown in FIG. 2;

FIG. 5 is an example of data stored in a flow consumption master shown in FIG. 2;

FIG. 6 is an example of work data shown in FIG. 2;

FIG. 7 is an example of flow data shown in FIG. 2;

FIG. 8 is an example of staff data shown in FIG. 2;

FIG. 9 is an example of work display data shown in FIG. 2;

FIG. 10 is an example of flow display data shown in FIG. 2;

FIG. 11 is a flowchart of a processing performed by the operation-analysis support device shown in FIG. 2;

FIG. 12 is an example of the workflow chart when man-hour represents a first axis;

FIG. 13 is an example of the workflow chart when some staff shown in the chart of FIG. 12 is changed;

FIG. 14 is an example of the workflow chart when cost represents the first axis;

FIG. 15 is an example of the workflow chart when some staff shown in the chart of FIG. 14 is changed;

FIG. 16 is a functional block diagram of an example of a computer that executes an operation-analysis support program; and

FIG. 17 is an example of a conventional workflow chart.

### DETAILED DESCRIPTION

Exemplary embodiments of the present invention will be described below with reference to accompanying drawings.

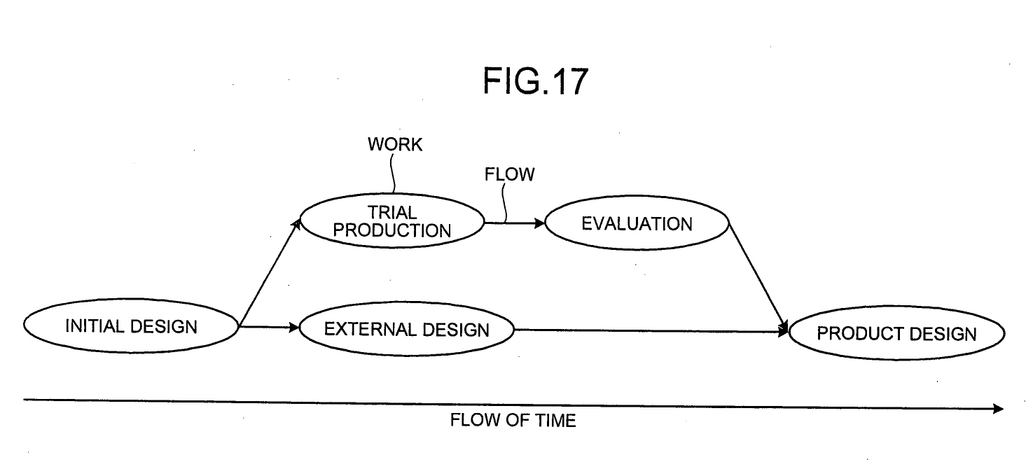

First, differences between a conventional workflow chart and a workflow chart according to an embodiment of the present invention is described. FIG. 17 is an example of a conventional workflow chart. A block expresses a work and a line connects a preceding work with a succeeding work to express a flow, according to the flow of time. With the conventional workflow chart, the workflow can be easily understood, however, consumption amounts of each work and each flow, such as consumption of time and resources, cannot be expressed.

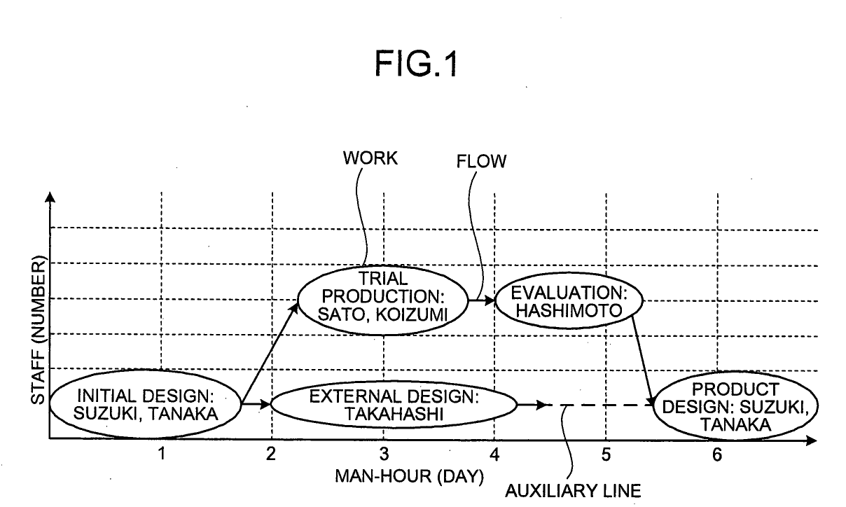

FIG. 1 is an example of the workflow chart according to an embodiment of the present invention. Consumption amounts of the blocks and the lines are expressed by sizes of the blocks and the lines. In this flowchart, the length along a horizontal axis (first axis) expresses unit time required (time consumption), while the length along a vertical axis (second axis) expresses staff required (resource consumption). Therefore, differences in the consumption amounts between blocks and lines can be grasped at a glance.

In the workflow chart of the embodiment, the consumption amount of a flow is not expressed by the length of a line per se, but by the corresponding amount of a parameter represented along a first axis (along a horizontal axis shown in FIG. 1). If the consumption amount of a flow is expressed by the length of the line per se, freedom in laying out the blocks is reduced, resulting in a workflow chart that is hard to understand. When the consumption amount of a flow is expressed by the corresponding amount of the parameter represented along a first axis, the blocks of works can be freely laid out along a second axis (along a vertical axis shown in FIG. 1). As a result, a workflow chart that is easy to understand is generated.

However, when consumption amounts of flows are expressed by the corresponding amount of the parameter along a first axis, a problem arises when the workflow separates into two or more flows. After initial design is performed, the flow shown in FIG. 1 separates into a flow for trial production and a flow for external design. The two flows join again at the same work, which is product design. However, because the time required of the two flows is different, the work at which the two flows join cannot be laid out at an appropriate position.

To solve this problem, the embodiment uses auxiliary lines that are distinguishable from those expressing flows. Specifically, the block of the work where the two flows join, is connected to the flow that is furthest from the starting point, and is connected to the other flow by an auxiliary line. An auxiliary line is shown with a dashed line in the example of FIG. 1. However, any other kind of line can be used, such as a thick line or a line of a different color, as long as it can be distinguished from the lines expressing the flows.

Information on staff performing a work is output to the corresponding block. The staff information including coefficients representing skill levels for each work is stored in a memory unit. Thus, every time the staff changes, the display in the workflow chart changes. For example, a staff that is highly skilled at initial design can complete the work faster, so that the length of the block of initial design becomes smaller along the horizontal axis, which causes other blocks and lines to shift toward the starting point.

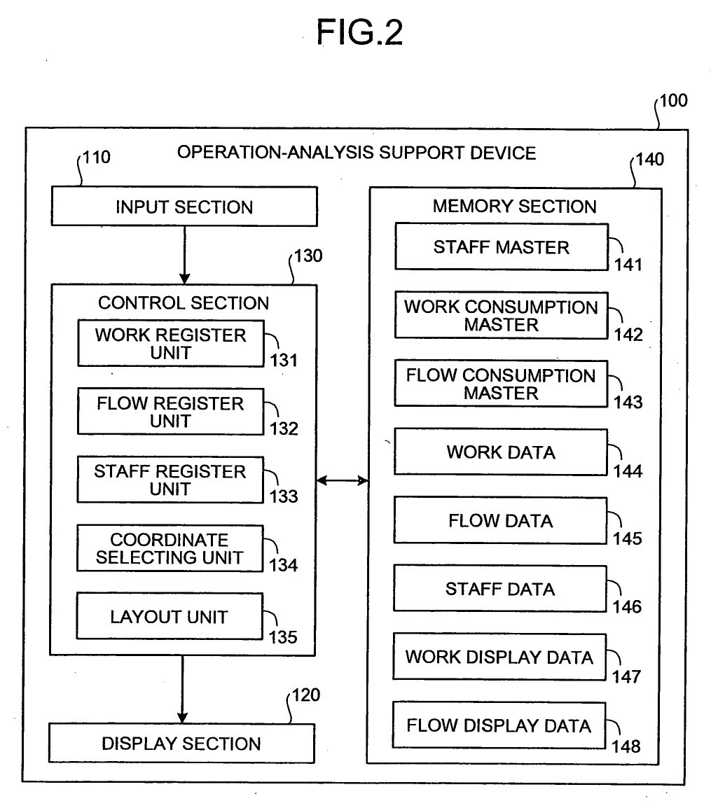

FIG. 2 is a block diagram of an operation-analysis support device that generates and displays a workflow chart, according to the embodiment of the present invention. An operation-analysis support device 100 includes an input section 110, a display section 120, a control section 130, and a memory section 140. The input section 110 receives information that is input by a user. The display section 120 displays characters and graphics.

The control section 130 controls the entire operation-analysis support device 100, including a work register unit 131, a flow register unit 132, a staff register unit 133, a coordinate selecting unit 134, and a layout unit 135. The work register unit 131 registers work information input from a user to work data 144 in the memory section 140. The work information means name and type of a work, and time required for a staff of standard skill level to complete a work.

The flow register unit 132 registers flow information input from a user to flow data 145 in the memory section 140. The flow data means information on relationships between preceding and succeeding works registered in the work data 144. The staff register unit 133 registers staff information to staff data 146 in the memory section 140. The staff information indicates which staff will perform each work registered in the work data 144.

A user selects parameters to be represented along first and second axes. The selections are input to the coordinate selecting unit 134. In the embodiment, parameters for the first axis are time or cost, and parameters for the second axis are time, cost, or number of staff. The first axis cannot be based on number of staff, because there is no such concept of number of staff required for a flow that corresponds to a transitional part between works. With the coordinate selecting unit 134, a user can also select which parameter is to be represented in a horizontal axis.

The layout unit 135 generates a workflow chart based on information stored in the memory section 140, and outputs the workflow chart to the display section 120. Specifically, the layout unit 135 determines sizes for each block and each line, and then connects and lays out the blocks and the lines. The method of determining the sizes is described later.

The memory section 140 stores various information, including a staff master 141, a work consumption master 142, a flow consumption master 143, the work data 144, the flow data 145, the staff data 146, work display data 147, and flow display data 148.

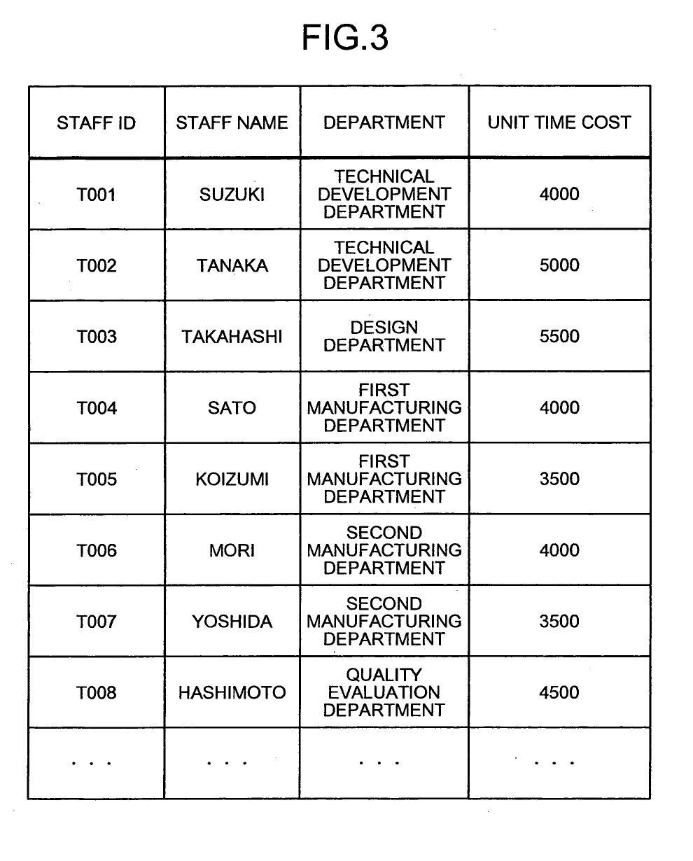

The staff master 141 is pre-stored data on staff that might perform each work. FIG. 3 is an example of data stored in the staff master 141 shown in FIG. 2. The example includes items of staff ID, staff name, department, and unit time cost. The staff ID is an identification code of a staff, and the staff name is a name of a staff. The department is a department to which a staff belongs, and the unit time cost is manpower cost per hour for each staff.

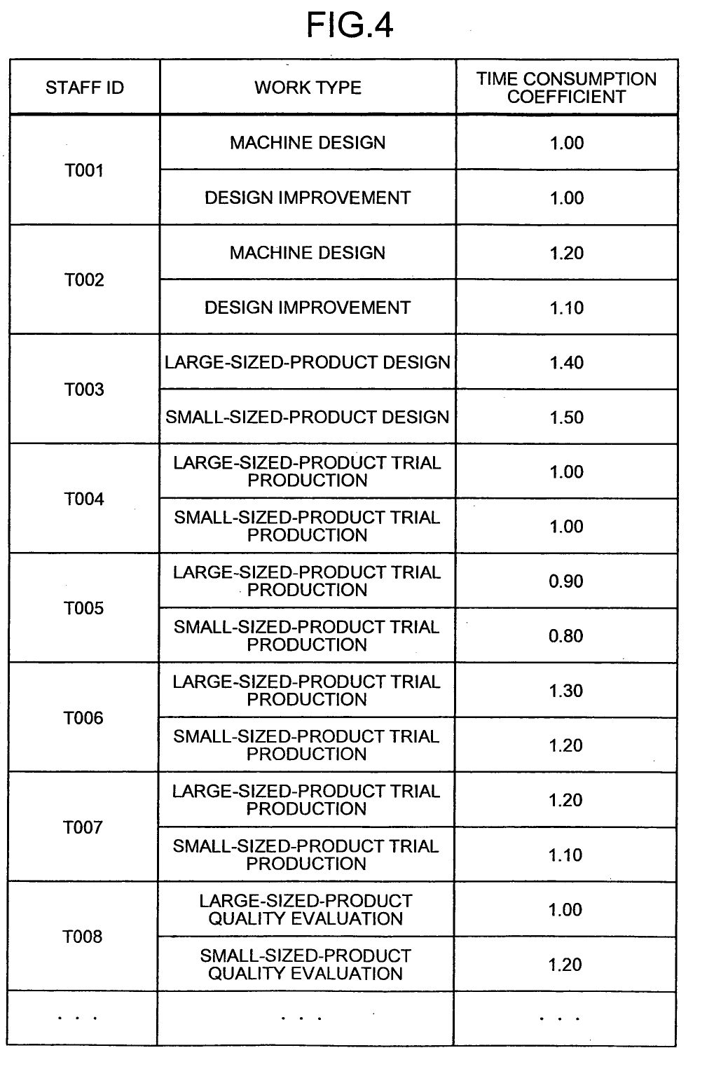

The work consumption master 142 is pre-stored data on skill levels of the staff that can perform the work, for each type of work. FIG. 4 is an example of data stored in the work consumption master 142 shown in FIG. 2. The example includes items of staff ID, work type, and time consumption coefficient. The staff ID is an identification code of a staff, and corresponds to that of the staff master 141. The work type represents a type of work. The time consumption coefficient represents a skill level of a staff for a type of work. For example, if the time consumption coefficient is two, the skill level of the staff for the corresponding work type is two times higher than that of a standard level. In other words, the time required to complete the work is half that of a standard level.

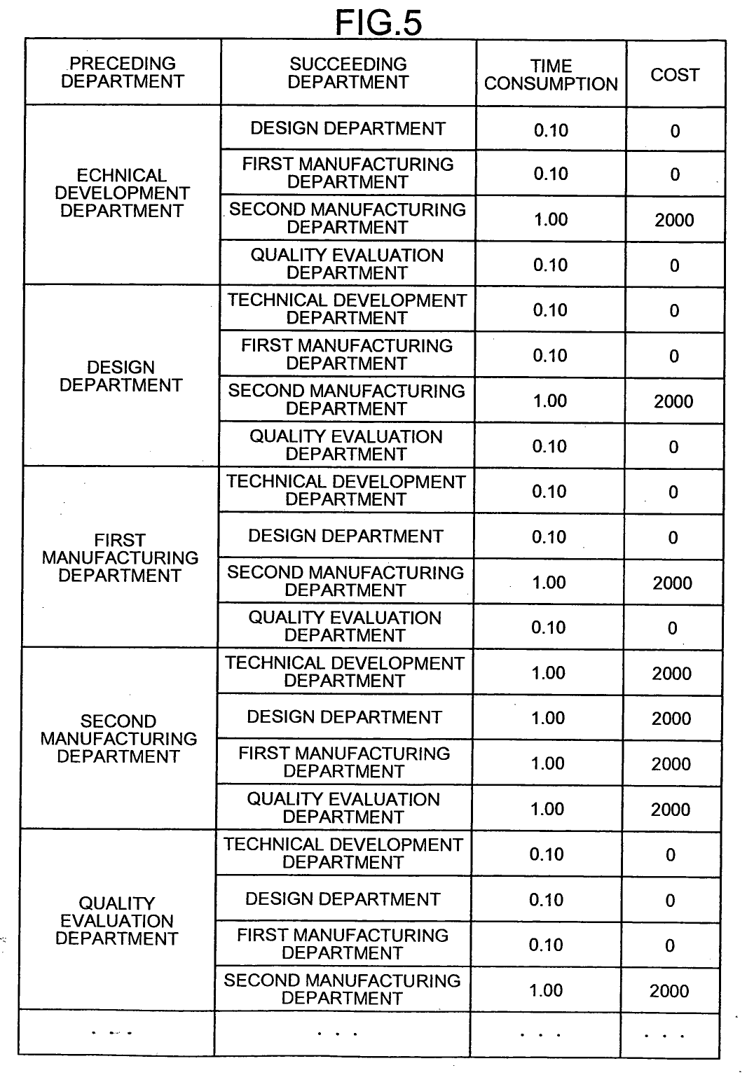

The flow consumption master 143 is pre-stored data of consumption amounts required when a work is passed to another department. FIG. 5 is an example of data stored in the flow consumption master 143 shown in FIG. 2. The example includes items of preceding department, succeeding department, time consumption, and cost. The preceding department performs a preceding work, and the succeeding department performs a succeeding work. The time consumption and the cost are time and cost required to pass a work from a preceding department to a succeeding department, respectively. The time consumption and the cost vary according to physical distances and levels of intimacy between departments.

The consumption amounts of each flow can be obtained not only from a combination of two departments, but also from a combination of two staff. In the case between two staff, the flow consumption master 143 includes time and cost required to pass work from preceding staff to succeeding staff.

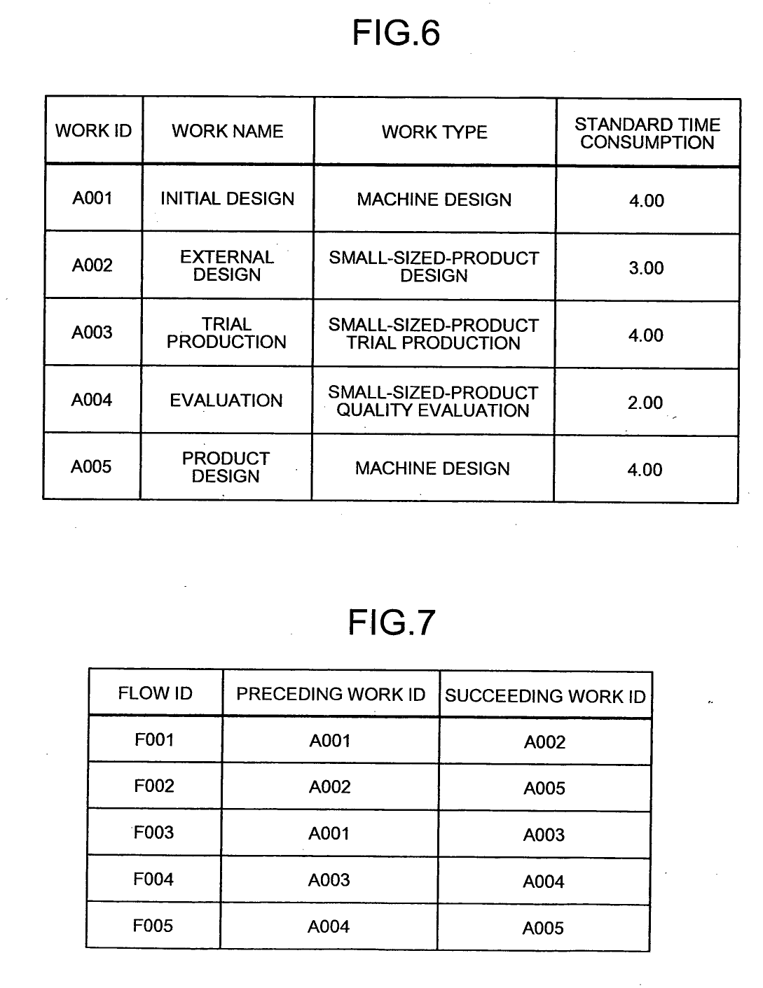

The work data 144 is work information input from a user and registered to the work register unit 131. FIG. 6 is an example of the work data 144 shown in FIG. 2. The example includes items of work ID, work name, work type, and standard time consumption. The work ID is an identification code of a work, and the work name is a name of a work. The work type is a name of a type of work, and the standard time consumption is time required for a staff of standard skill level to complete a work.

The flow data 145 is flow information input from a user and registered to the flow register unit 132. FIG. 7 is an example of the flow data 145 shown in FIG. 2. The example includes items of flow ID, preceding work ID, and succeeding work ID. The flow ID is an identification code of a flow. The preceding work ID and the succeeding work ID are identification codes for a preceding work and a succeeding work, respectively.

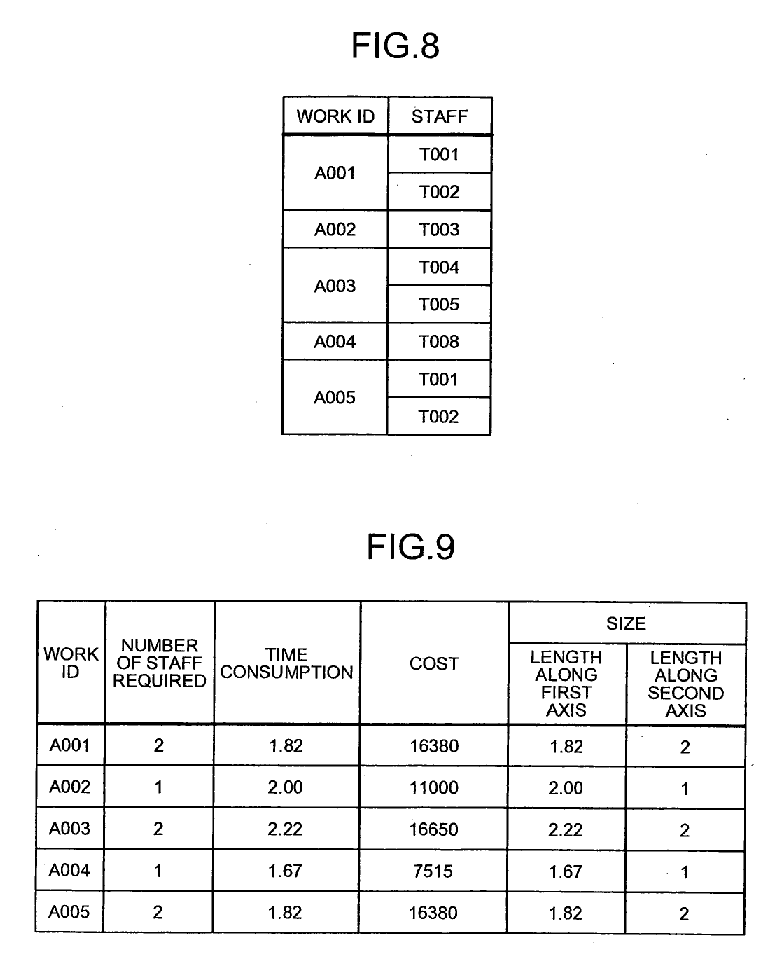

The staff data 146 is staff information input from a user and registered to the staff register unit 133. FIG. 8 is an example of the staff data 146 shown in FIG. 2. The example includes items of work ID and staff ID. The work ID is an identification code for a work, and the staff ID is an identification code of a staff that performs a work. A plurality of staff ID can be registered for a single work ID.

The work display data 147 is prepared by the layout unit 135 and is used to lay out blocks expressing works. FIG. 9 is an example of the work display data 147 shown in FIG. 2. The example includes items of work ID, number of staff required, time consumption, cost, length along a first axis, and length along a second axis. The work ID is an identification code for a work.

The number of staff required is number of staff registered for a work in the staff data 146. For example, two staff T001 and T002 are registered for work A001 in the staff data 146. Thus, the number of staff required is two.

The time consumption is time required for staff registered in the staff data 146 to complete a work. Time consumption coefficients of staff are acquired from the work consumption master 142. Then, the time consumption is calculated using the following equation:
Time consumption=Standard time consumption in work data 144÷Sum of time consumption coefficients.
For example, the work type of work A001 is machine design, and the time consumption coefficients for machine design of staff T001 and T002 are 1.00 and 1.20, respectively. The standard time consumption for A001 registered in the work data 144 is 4.00. The time consumption for A001 is obtained by substituting these values in the above equation, as follows:
4.00÷(1.00+1.20)≈1.82

The cost is cost required for a staff registered in the staff data 146 to perform a work. Unit time costs of staff are acquired from the staff master 141. Then, the cost is calculated using the following equation:
Cost=Time consumption obtained by above equation×Sum of unit time costs
For example, the unit time costs of T001 and T002 assigned to A001 are 4000 and 5000, respectively. The cost for A001 is obtained by substituting these values in the above equation, as follows:
1.82×(4000+5000)=16380

Lengths along the first axis and the second axis are determined by values of the number of staff required, the time consumption, or the cost. The parameter represented by each axis corresponds to the selection made at the coordinate selecting unit 134. In the example of FIG. 9, time is selected to represent a first axis, and number of staff required is selected to represent a second axis.

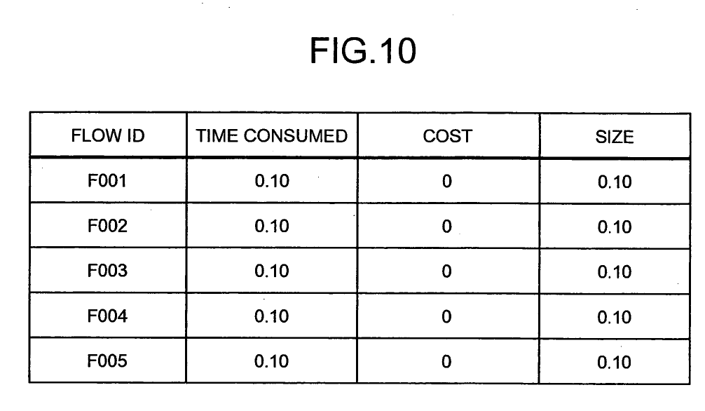

The flow display data 148 is prepared by the layout unit 135, and is used to lay out lines expressing flows. FIG. 10 is an example of the flow display data 148 shown in FIG. 2. The example includes items of flow ID, time consumption, cost, and size. The flow ID is an identification code for a flow.

The time consumption and the cost are time and cost required to pass a work from a department to which a staff performing a preceding work belongs, to a department to which a staff performing a succeeding work belongs. The time consumption and the cost are acquired from the flow consumption master 143. For example, the technical development department performs the work A001 that precedes a flow F001, and the design department performs a work A002 that succeeds the flow F001. The time 0.10 and the cost 0 required to pass the work between these departments can be acquired from the flow consumption master 143.

The size is determined by the time consumption or the cost, depending on the selection made at the coordinate selecting unit 134. In the example of FIG. 10, the time consumption is selected to represent sizes along the first axis.

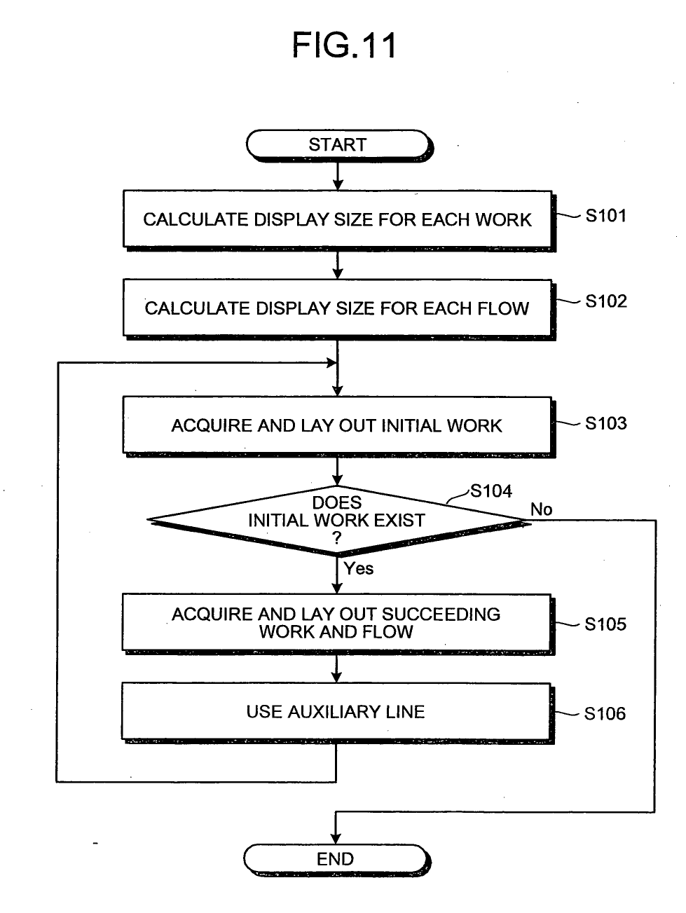

FIG. 11 is a flowchart of processing performed by the operation-analysis support device 100 shown in FIG. 2. Specifically, the processing when the layout unit 135 outputs a workflow chart is shown.

When the layout unit 135 receives an instruction to output a workflow chart, the layout unit 135 calculates a display size for each work registered in the work data 144, and generates the work display data 147 (step S101). Subsequently, the layout unit 135 calculates the display size for each flow registered in the flow data 145, and generates the flow display data 148 (step S102).

Then, the layout unit 135 acquires an unprocessed work to be positioned at a starting point, and lays out a block expressing such work (step S103). The work to be a starting point is registered only as a preceding work, and is not registered as a succeeding work, in the flow data 145. When there does not exist an unprocessed work to be a starting point (“No” in step S104), the processing ends.

When there exists an unprocessed work to be a starting point (“Yes” in step S104), after such work is laid out, succeeding flows and works are sequentially acquired and laid out (step S105). If a block cannot be connected to a line due to positional restrictions, an auxiliary line is used for the connection (step S106). When all succeeding flows and works are laid out, the system control returns to step S103 to lay out another work as a starting point.

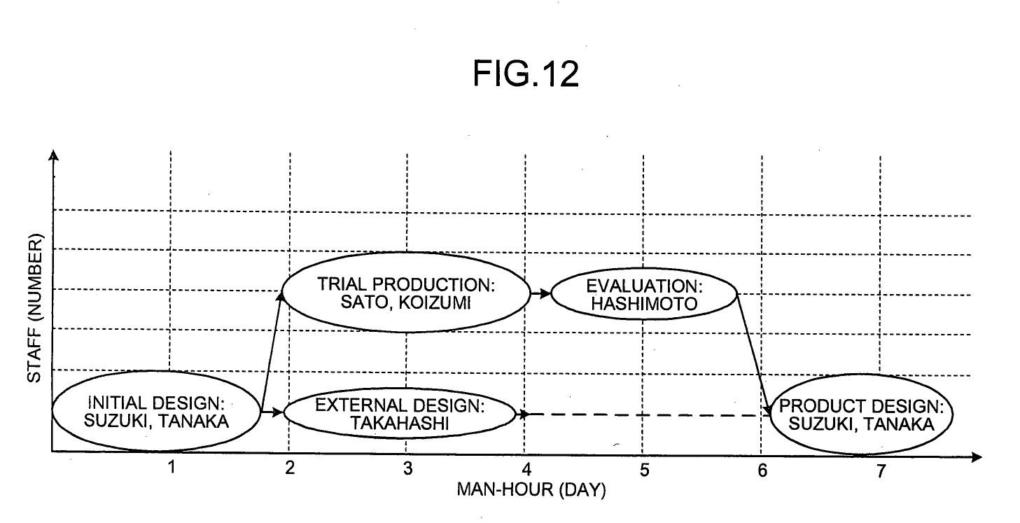

Next, specific examples of workflow charts output by the operation-analysis support device 100 shown in FIG. 2 will be described. FIG. 12 is an example of a workflow chart when man-hour represents a first axis. Differences in time consumption between works and flows can be easily grasped from their lengths along the horizontal axis, selected as the first axis.

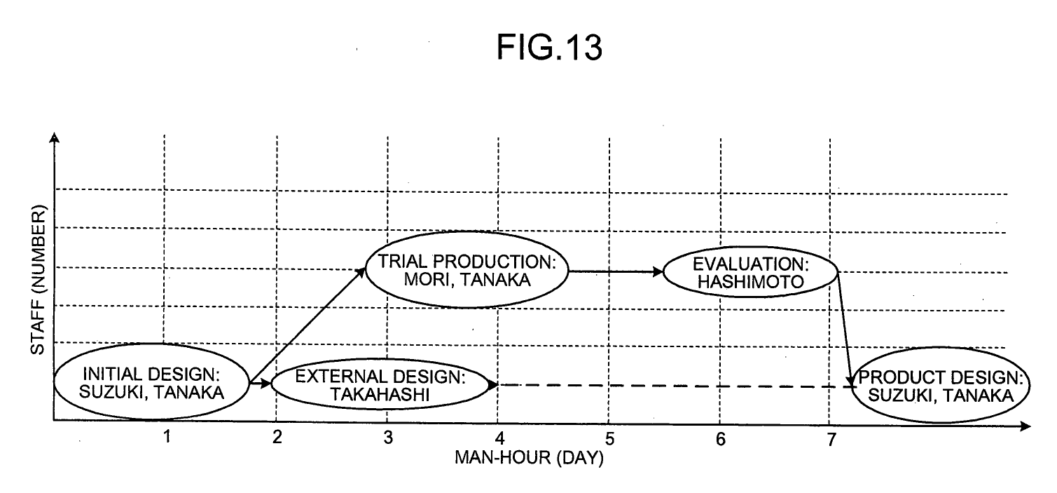

The workflow chart changes by changing the staff. FIG. 13 is an example of the workflow chart when some of the staff shown in the chart of FIG. 12 is changed. Compared to the example in FIG. 12, the staff for trial production have higher skill levels. Therefore, less time is required for the trial production. However, because the flow to pass the work requires more time, the total time consumption is longer than the example in FIG. 12.

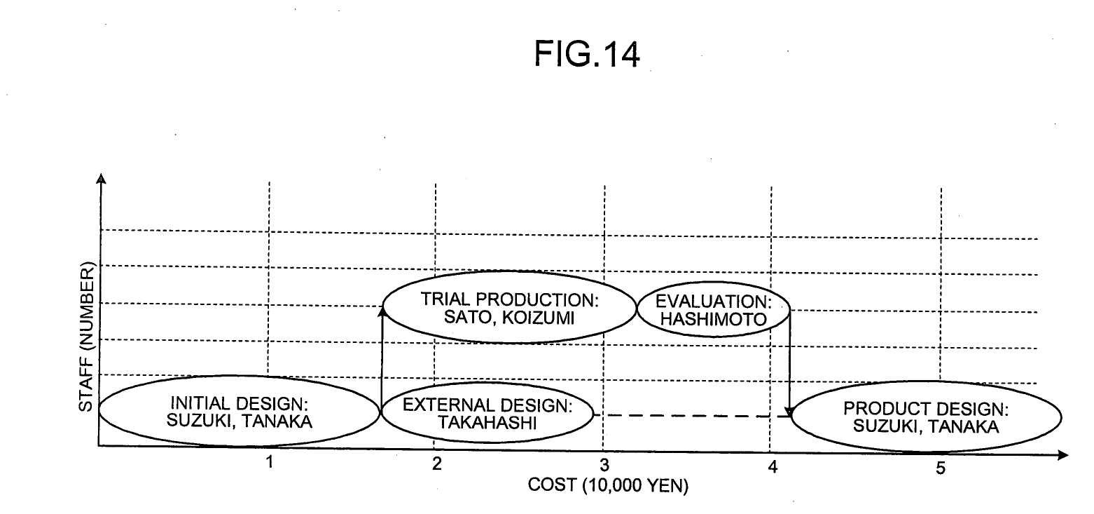

Cost can also be selected to represent the first axis. FIG. 14 is an example of the workflow chart when cost represents the first axis. In the example, differences in time consumption between works and flows can be easily grasped by their lengths along the horizontal axis, selected as the first axis.

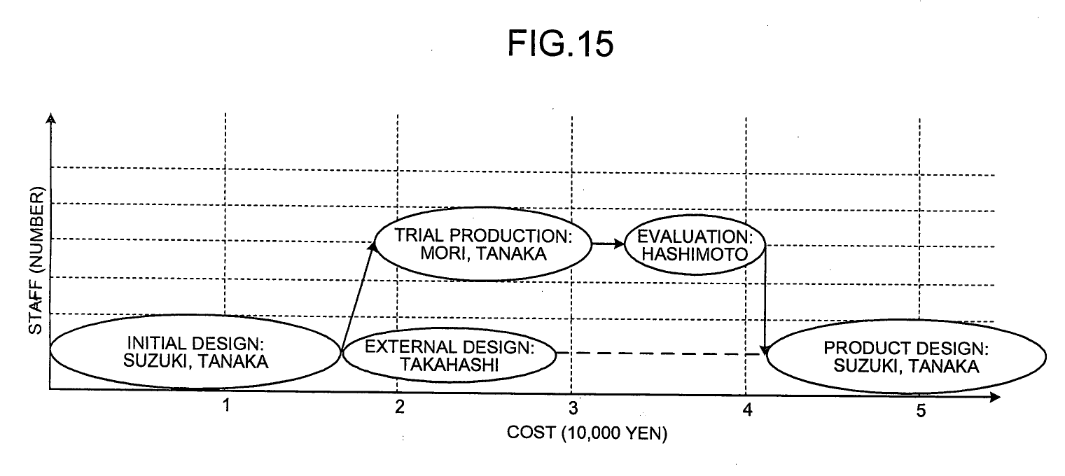

In this case, the workflow chart can also change by changing the staff. FIG. 15 is an example of the workflow chart when some of the staff shown in the chart of FIG. 14 is changed. Compared to the example in FIG. 14, the staff for trial production has higher skill levels of but lower unit time cost. Therefore, less cost is required for the trial production. However, because the flow to pass the work requires more cost, the total cost is the same as the example in FIG. 14.

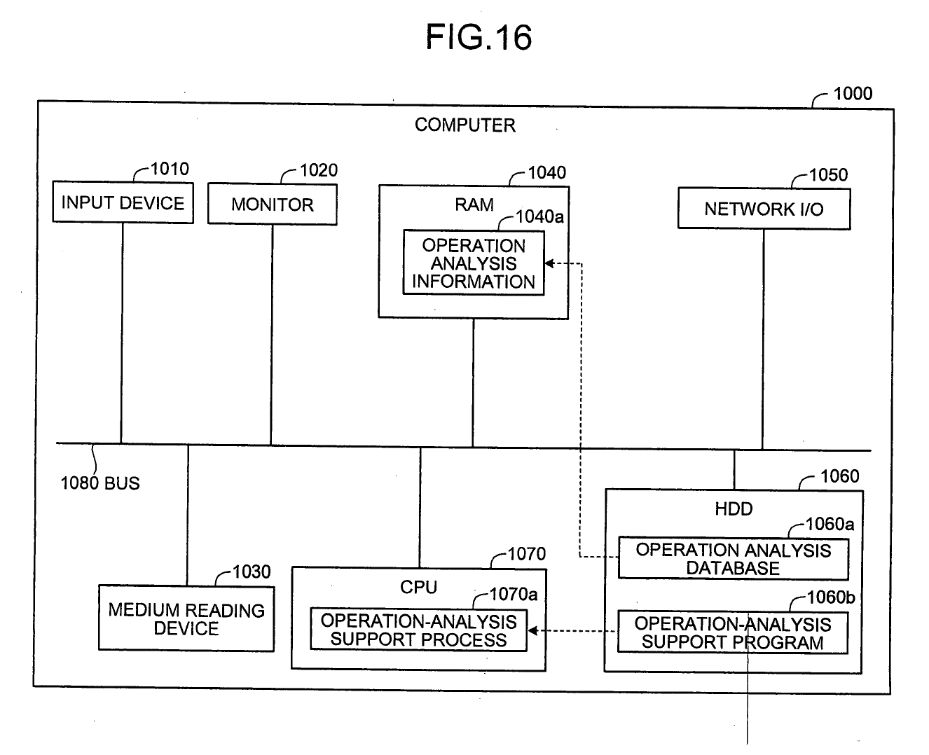

The process of the embodiment can be realized by executing a computer program stored in a computer-readable recording medium. FIG. 16 is a functional block diagram of an example of a computer that executes an operation-analysis support program according to an embodiment of the present invention.

A computer 1000 includes an input device 1010, a monitor 1020, a medium reading device 1030 that reads the programs stored in the recording medium, a random access memory (RAM) 1040 that temporarily stores various information, a network interface 1050 that exchanges data with another computer through a network, a hard disk drive (HDD) 1060, a CPU 1070, and a bus 1080.

The HDD 1060 stores an operation-analysis support program 1060b that realizes the same functions as those of the operation-analysis support device 100. The CPU 1070 reads the operation-analysis support program 1060b from the HDD 1060, and executes it, so that the program functions as an operation-analysis support process 1070a. The operation-analysis support process 1070a corresponds to the control section 130 shown in FIG. 2.

The CPU 1070 reads an operation-analysis support database 1060a from the HDD 1060, and stores it as operation analysis information 1040a in the RAM 1040. Data processing is executed based on the operation analysis information 1040a. An operation-analysis support database 1060a corresponds to various data in the memory section 140 shown in FIG. 2.

The operation-analysis support program 1060b does not have to be stored in the HDD 1060, but can be stored in any recording medium such as a CD-ROM, to be executed by the computer 1000. Moreover, the program can be stored in another computer (or server) connected to the computer 1000 though public lines, the Internet, LAN, or WAN, to be executed by the computer 1000.

Resource consumption of a work can be expressed not only by number of staff, but also by number of facilities, etc.

According to the present invention, a workflow chart output by the operation-analysis support device is a plot of a plurality of blocks connected by a plurality of lines on a coordinate system that has at least a first axis and a second axis. Each of the blocks expresses a work and each of the lines expresses a flow between the works. Each block is laid out in a size and at a position along the first axis and the second axis based on a first parameter and a second parameter, respectively. Each line is laid out in a size and at a position along the first axis based on a first parameter.

The first parameter can be time or cost required for a work or a flow. The second parameter can be time or cost, or resources such as number of staff or facilities, required for a work.

Therefore, differences in consumption amounts between blocks and lines can be grasped at a glance.

Moreover, a block and a line can be connected by an auxiliary line, distinguishable from lines that express flows, when the block and the line cannot be connected because of a positional restriction in the workflow chart. Therefore, works and lines can be connected by auxiliary lines to express preceding and succeeding relations, while the sizes of lines expressing flows correctly represent consumption amounts.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to generate and display a workflow chart, wherein the workflow chart is a plot of a plurality of blocks connected by a plurality of lines on a coordinate system having at least a first axis and a second axis, wherein each of the blocks expresses a work and each of the lines expresses a flow between the works, wherein the computer program causes the computer to execute:
laying out each of the blocks in a size and at a position along the first axis and the second axis based on a first parameter and a second parameter, respectively, and laying out each of the lines in a size and at a position along the first axis based on the first parameter.

2. The computer-readable recording medium according to claim 1, wherein the first parameter is time required for the works and the flows.

3. The computer-readable recording medium according to claim 1, wherein the first parameter is cost required for the works and the flows.

4. The computer-readable recording medium according to claim 2, wherein the second parameter is resources required for the works.

5. The computer-readable recording medium according to claim 3, wherein the second parameter is resources required for the works.

6. The computer-readable recording medium according to claim 2, wherein the second parameter is cost required for the works.

7. The computer-readable recording medium according to claim 3, wherein the second parameter is time required for the works.

8. The computer-readable recording medium according to claim 1, wherein, when a block and a line need to be connected but cannot be connected by a line that expresses a flow because of a positional restriction in the workflow chart, the block and the line are connected by another type of line distinguishable from the lines that express the flows.

9. The computer-readable recording medium according to claim 1, further comprising storing information on staff performing corresponding work, wherein the laying out includes calculating first parameters and second parameters for works and flows based on the information stored in the memory unit.

10. An operation-analysis support device that generates and displays a workflow chart, wherein the workflow chart is a plot of a plurality of blocks connected by a plurality of lines on a coordinate system having at least a first axis and a second axis, wherein each of the blocks expresses a work and each of the lines expresses a flow between the works, comprising:
a layout unit that lays out each of the blocks in a size and at a position along the first axis and the second axis based on a first parameter and a second parameter, respectively, and lays out each of the lines in a size and at a position along the first axis based on the first parameter.

11. The operation-analysis support device according to claim 10, wherein the first parameter is time required for the works and the flows.

12. The operation-analysis support device according to claim 10, wherein the first parameter is cost required for the works and the flows.

13. The operation-analysis support device according to claim 11, wherein the second parameter is resources required for the works.

14. The operation-analysis support device according to claim 12, wherein the second parameter is resources required for the works.

15. The operation-analysis support device according to claim 11, wherein the second parameter is cost required for the works.

16. The operation-analysis support device according to claim 12, wherein the second parameter is time required for the works.

17. The operation-analysis support device according to claim 10, wherein, when a block and a line need to be connected but cannot be connected by a line that expresses a flow because of a positional restriction in the workflow chart, the block and the line are connected by another type of line distinguishable from the lines that express the flows.

18. The operation-analysis support device according to claim 10, further comprising a memory unit that stores information on staff performing corresponding work, wherein the layout unit calculates first parameters and second parameters for works and flows based on the information stored in the memory unit.

19. An operation-analysis support method that generates and displays a workflow chart, wherein the workflow chart is a plot of a plurality of blocks connected by a plurality of lines on a coordinate system having at least a first axis and a second axis, wherein each of the blocks expresses a work and each of the lines expresses a flow between the works, the method comprising:
laying out each of the blocks in a size and at a position along the first axis and the second axis based on a first parameter and a second parameter, respectively, and laying out each of the lines in a size and at a position along the first axis based on the first parameter.

20. The operation-analysis support method according to claim 19, wherein the first parameter is time required for the works and the flows.

21. The operation-analysis support method according to claim 19, wherein the first parameter is cost required for the works and the flows.

22. The operation-analysis support method according to claim 20, wherein the second parameter is resources required for the works.

23. The operation-analysis support method according to claim 21, wherein the second parameter is resources required for the works.

24. The operation-analysis support method according to claim 20, wherein the second parameter is cost required for the works.

25. The operation-analysis support method according to claim 21, wherein the second parameter is time required for the works.

26. The operation-analysis support method according to claim 19, wherein, when a block and a line need to be connected but cannot be connected by a line that expresses a flow because of a positional restriction in the workflow chart, the block and the line are connected by another type of line distinguishable from the lines that express the flows.

27. The operation-analysis support method according to claim 19, further comprising storing information on staff performing corresponding work, wherein the laying out includes calculating first parameters and second parameters for works and flows based on the information stored in the memory unit.
